(19) United States
(12) Patent Application Publication
(10) Pub. No.: US 2015/0178751 A1
(43) Pub. Date: Jun. 25, 2015

(54) FUEL PRICE DATA GENERATION

(71) Applicant: Kalibrate Technologies PLC, Manchester (GB)

(72) Inventor: Adrian Preston, Manchester (GB)

(21) Appl. No.: 14/138,964

(22) Filed: Dec. 23, 2013

(51) Int. Cl. G06Q 30/02; G06Q 50/06

(52) U.S. Cl. CPC G06Q 30/0206; G06Q 30/0205; G06Q 50/06

(57) ABSTRACT

Methods and devices for generating fuel price data comprising: receiving fuel price data associated with a retail fuel site; receiving a location associated with the received fuel price data; receiving, as input to the processor, a location associated with the retail fuel site; and if the location associated with the received fuel price data and the location associated with the retail fuel site satisfy a predetermined criterion, generating said fuel price data based upon the received fuel price data.

### TECHNICAL FIELD

The present invention relates to generation of fuel price data.

### BACKGROUND OF THE INVENTION

In many industries, commercial organisations have to determine prices at which their products are to be sold. Determination of such prices will need to take into account various factors. For example, a particular commercial organisation may wish to ensure that its prices are within a predetermined limit of a particular competitor's prices. Similarly, a commercial organisation may wish to ensure that a particular constraint is applied such that prices of different products sold by that organisation have a predetermined relationship with one another.

A particular industry in which prices need to be determined is the fuel industry. In particular, it is necessary to determine prices at which fuel is to be sold at retail fuel sites. Traditionally, prices at which retail fuel sites sell fuel have been determined by skilled analysts who have mentally collated and processed data representing various parameters which need to be taken into account. Having carried out this processing, analysts can typically determine pricing, often convening at a meeting at which a plurality of pricing analysts make various strategy decisions.

More recently, automated systems for determining retail fuel prices have been used. In these automated systems data required for determining pricing is collected and provided to a pricing system which is often located remotely from the retail site. The pricing system uses the provided data together with other information to determine information useful for optimising fuel prices at the retail site. The information generated by the pricing system generally takes the form of recommended pricing for fuels that satisfies the desired pricing strategy, but may also include other useful information such as reports and predictions of competitor prices.

Typically, a plurality of retail fuel sites operate in a particular region, and prices charged by different retail fuel sites in a particular region will routinely need to be taken into account in determining pricing for a retail fuel site. Additionally, prices charged in different regions in associated retail fuel sites may also need to be taken into account. There remains a need for improvements in methods and systems for collecting information used in determining pricing for a retail fuel site.

### SUMMARY

It is an object of the invention to provide improvements in systems and methods for generating fuel price data.

According to a first aspect of the invention there is provided a method of generating fuel price data, the method comprising: receiving, as input to the processor, fuel price data associated with a retail fuel site; receiving, as input to the processor, a location associated with the received fuel price data; receiving, as input to the processor, a location associated with the retail fuel site; and if the location associated with the received fuel price data and the location associated with the retail fuel site satisfy a predetermined criterion, generating said fuel price data based upon the received fuel price data.

In this way, fuel price data may be processed to determine whether received fuel price data is likely to be reliable based upon its location and only used in the generation of further fuel price data if the data is determined to be reliable.

The fuel price data associated with a retail fuel site may be received from a mobile computer. The mobile computer may for example be a mobile telephone or a tablet computer.

The location associated with the received fuel price data may be a location associated with the mobile computer. The location may for example be a location associated with where the fuel price data is entered to the mobile computer or may be a location associated with where the mobile computer is located when the fuel price data is transmitted to a server. The location may be automatically determined using for example GPS functionality of the mobile computer. The location associated with the retail fuel site may therefore comprise a geographical location of the retail fuel site.

The predetermined criterion may be based upon a difference between the location associated with the received fuel price data and the location associated with the retail fuel site.

Generating the fuel price data may comprise processing the received fuel price data associated with the retail fuel site. For example, the fuel price data that is received may be used in the determination of fuel price recommendations for a retail fuel site if they are confirmed to be acceptable.

The generated fuel price data may comprise fuel prices associated with a further retail fuel site. The retail fuel site may for example be a direct competitor for fuel sales of said further retail fuel site.

The method may further comprise determining if the location associated with the received fuel price data and the location associated with the retail fuel site satisfy a predetermined criterion. The determining may comprise generating data indicating a relationship between the location associated with the received fuel price data and the location associated with the retail fuel site.

The data indicating a relationship may comprise a graphical indication of the relationship. The method may further comprise providing the data indicating a relationship to a user. Providing the data indicating a relationship to a user may comprise transmitting the data indicating a relationship to a mobile device associated with the user. The user may for example be a manager of a retail fuel site and the method may therefore allow a manager of a retail fuel site to check fuel price data received from a fuel price collector without being required to be at a desk. Such mobile price approval can allow fuel price data to be approved more quickly and thereby improve the data used in modelling to generate fuel prices for fuel sites.

The method may further comprise receiving user input based upon the data indicating a relationship, and the predetermined criterion may based upon the user input. That is, the fuel price data may be used only if a further user confirms that the fuel price data is acceptable.

Generating data indicating a relationship between the location associated with the received fuel price data and the location associated with the retail fuel site may comprise processing the relationship based upon a plurality of predetermined criterion and selecting the data indicating a relationship from a plurality of respective relationships based upon the processing.

According to a second aspect of the invention there is provided a method of generating fuel price data the method comprising: receiving, as input to the processor, fuel price data associated with a retail fuel site from a mobile device associated with a first user; receiving, as input to the processor, location data associated with the received fuel price data, the location data being associated with a location of the mobile device associated with the first user; receiving, as input to the processor, location data associated with the retail fuel site; determining, by the processor, a relationship between the location associated with the received fuel price data and the location data associated with the retail fuel site; and transmitting, by the processor, data associated with said relationship to a mobile device associated with a second user; wherein the server is further arranged to receive, as input to the processor, data associated with said transmitted data from said second mobile device; and process the received fuel price data based upon the received data.

According to a third aspect of the invention there is provided a system for generating fuel price data, the system comprising: a server; a mobile device associated with a first user; and a mobile device associated with a second user. The mobile device associated with the first user is arranged to: receive fuel price data associated with a retail fuel site; and transmit the fuel price data and a location associated with the fuel price data to the server. The server is arranged to: receive the fuel price data and location associated with the fuel price data; receive a location associated with the retail fuel site; process the location associated with the fuel price data and the location associated with the retail fuel site to generate relationship data; and transmit the relationship data to the mobile device associated with the second user. The mobile device associated with the second user is arranged to: receive the relationship data from the server; receive input data based upon the relationship data; and transmit the input data to the server. Fuel price data is generated based upon the received fuel price data associated with the retail fuel site and the input data transmitted to the server.

The third aspect of the invention therefore provides a novel arrangement of devices that provides a flexible system for price approval.

The mobile device associated with the first user and the mobile device associated with the second user are generally different mobile devices, such as a mobile telephone or tablet computer belonging to the respective user, however in some embodiments the mobile device associated with the first user and the mobile device associated with the second user may be the same mobile device arranged to provide different interfaces and data to the respective user based upon a user login to the device or an application running on the device.

Aspects of the invention may be combined. For example, it will be apparent to a person skilled in the art that features of the first aspect of the invention can be used in the other aspects of the invention.

Aspects of the invention can be implemented in any convenient form. For example computer programs may be provided to carry out the methods described herein. Such computer programs may be carried on appropriate computer readable media which term includes appropriate non-transient tangible storage devices (e.g. discs). Aspects of the invention can also be implemented by way of appropriately programmed computers and other apparatus.

### BRIEF DESCRIPTION OF THE DRAWINGS

Embodiments of the invention will now be described, by way of example, with reference to the accompanying drawings, in which:

FIG. 1 is a schematic illustration of part of a network of associated retail fuel sites in communication with a pricing system;

FIG. 2 is a schematic illustration of the pricing system of FIG. 1;

FIG. 2A is a schematic functional block diagram of part of the pricing system of FIG. 1;

FIG. 3 is a schematic illustration showing a computer associated with the pricing system of FIG. 2 in further detail;

FIG. 4 is a schematic illustration of an arrangement of devices for competitor price approval;

FIG. 5 is a schematic illustration of a screen for inputting prices of competitors of a fuel site;

FIG. 6 is a schematic illustration of a screen for inputting competitor prices;

FIG. 7 is a schematic illustration of a screen for displaying surveys for review;

FIG. 8 is a schematic illustration of a screen for reviewing a competitor price survey;

FIG. 9 is an entity diagram showing part of a database structure for storing data used in the invention;

FIG. 10 is a schematic illustration of data processing in accordance with the invention.

### DETAILED DESCRIPTION

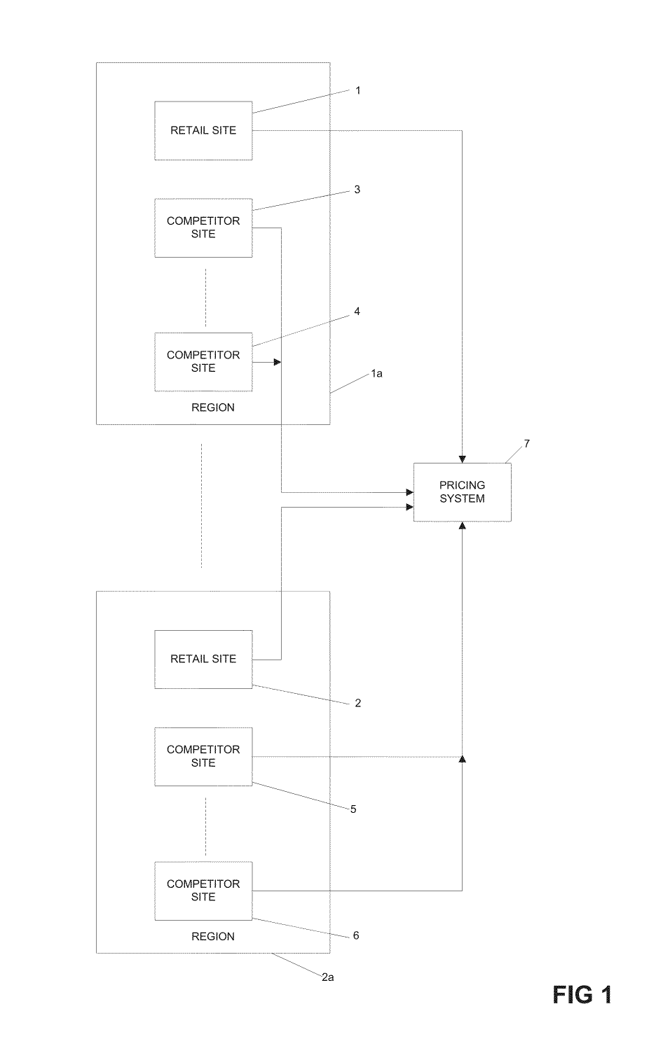

Referring first to FIG. 1 part of a network of associated retail fuel sites, 1, 2 is illustrated. Each of the associated retail fuel sites may be, for example, owned or operated by a single commercial entity, or may be supplied by a particular fuel supplier. Each of the associated retail fuel sites 1, 2 has an associated region 1a, 2a which defines a geographical area in which competitor retail sites 3, 4, 5, 6 are considered to be direct competitors. That is, competitor sites 3, 4 which lie in region 1a are direct competitors of the first associated retail site 1 and competitor sites 5, 6 which lie in region 2a are direct competitors of the second associated retail site 2 such that sales of sites lying in region 1a affect sales of other sites lying in region 1a and sales of sites lying in region 2a affect sales of other sites lying in region 2a. It will be appreciated that a wider area such as a country will generally be divided into a plurality of regions in which retail sites compete with competitor sites. Regions may be selected based upon a geographical region such as an area surrounding a city or may be selected based upon other factors that determine competing sites such as sites located along a particular highway.

Associated retail fuel sites 1, 2 in the network of associated retail fuel sites may further be arranged in networks indicating groups of associated retail fuel sites that share a common pricing strategy such as retail fuel sites located at motorway service stations or retail fuel sites located in urban or rural areas. Additionally, associated retail fuel sites may be operated under various contract types and retail fuel sites operating under particular contract types may also be arranged into networks. Examples of contract types under which retail fuel sites may operate may include “company owned, company operated”, “company owned, franchisee operated”, “dealer owned, dealer operated” and “company owned, dealer operated”. The associated retail fuel sites and competitor retail fuel sites, networks and regions are used to construct a model defining interrelationships between associated retail fuel sites and competitor retail fuel sites. Where changes to the networks and regions subsequently occur, the model defining interrelationships between the sites is updated to reflect the changes.

A pricing system 7 is arranged to receive various data including data associated with each of the associated retail sites 1, 2 and data associated with competitor sites 3, 4, 5, 6. The pricing system 7 is arranged to process the received data and to generate various output data, in particular an optimal pricing strategy for each of the products at each of the associated retail sites 1, 2 based upon the provided information.

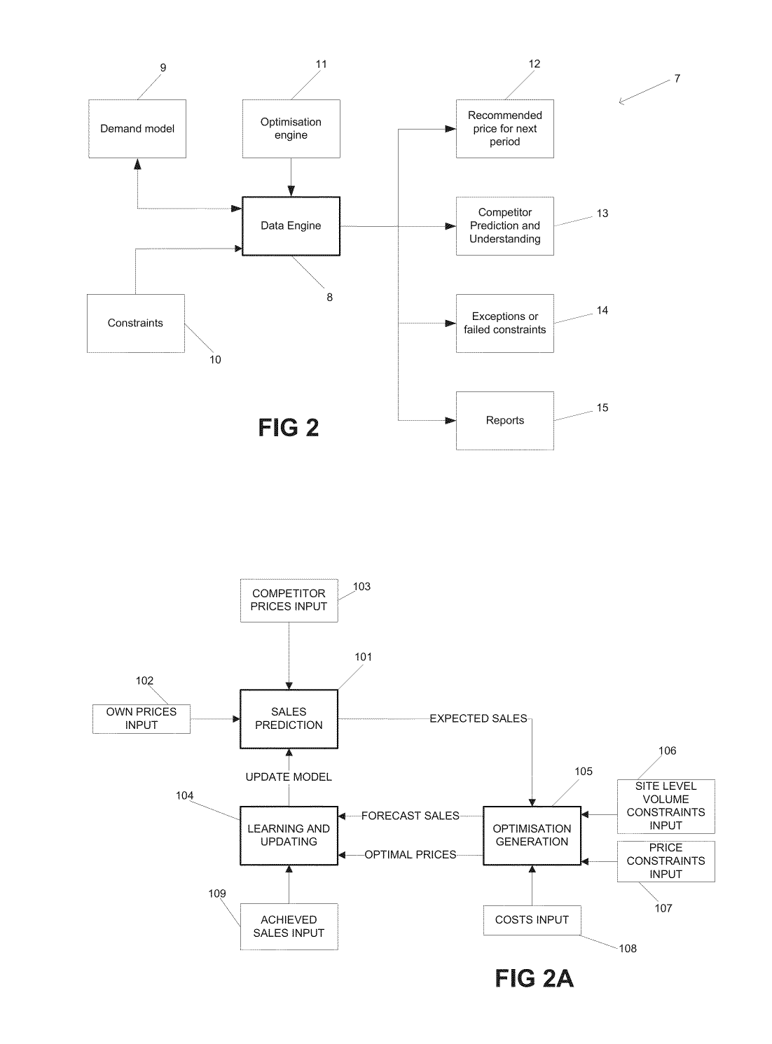

FIG. 2 shows operation of the pricing system 7 of FIG. 1 in more detail. It can be seen that the pricing system 7 takes various data as input, and generates various data as output as described above. Specifically, a data engine 8 takes as input a demand model 9 and constraints 10 and uses an optimisation engine 11. The demand model 9 forecasts sales volume for each product by site and time period. The demand model 9 uses past sales history at each site together with site prices and competitor site prices as well as elasticity values indicating sensitivity of customers to price changes for each product at each associated retail site 1, 2 and time period. The elasticity values provide an estimate of how demand for a particular product is likely to vary in response to price changes, either by an associated retail site 1, 2 or a competitor site 3, 4, 5, 6, and may be determined in an offline process using linear or non-linear regression modelling techniques based upon historic sales and price data. For example, stepwise or ridge regression may be used which are effective techniques for modelling historic price data which is generally highly correlated.

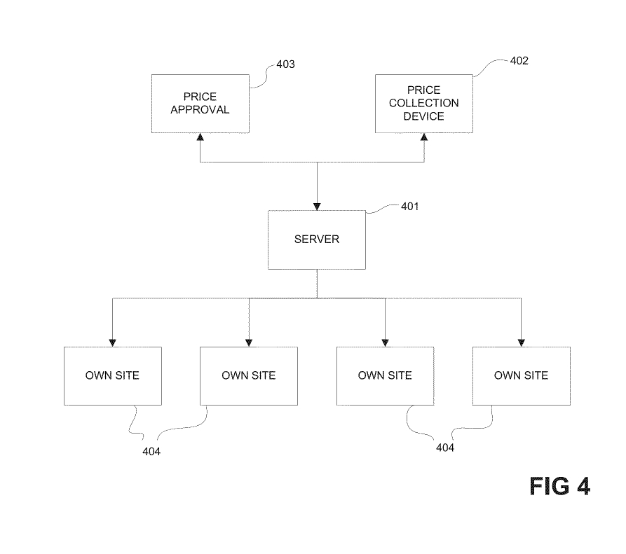

The retail site data and competitor site data may be provided to the pricing system 7 using a data link which automatically provides retail site data to the pricing system 7, for example at the end of each day. Competitor data is collected by the associated retail site 1, 2 and provided to the pricing system 7 in any convenient way, for example by using the same data link as used to provide retail site data or alternatively using mobile computing devices which are used by operatives to collect the competitor data from the competitor site and which provide the competitor data to the pricing system 7 over wireless telecommunications. Alternatively, data may be provided in any convenient way. An example user interface suitable for inputting site and competitor prices is described below with reference to FIG. 4.

The constraints 10 allows a user to specify rules defining pricing strategies by site and/or product. The rules take the form of price differentials and ranges which it is desirable are satisfied by prices at an associated retail site 1, 2. Price differentials determine a pricing position of a site relative to other competitor sites within a region. Price differentials are used to indicate a range of acceptable prices for a particular product relative to corresponding competitor prices within which the data engine 8 seeks to determine product prices which satisfy the specified price differentials. Price differentials may provide different ranges of acceptable prices relative to different competitors and in particular may include a differential relative to a main competitor and additionally or alternatively may include a differential relative to a different site in the network of associated retail fuel sites 1, 2, such that pricing at a first site in the network generally follows pricing at a second site in the network.

Price differentials may either be constraint-type differentials indicating constraints on prices that should be satisfied, often relative to a main competitor for a particular site, or guide-type differentials, which are optional constraints that are to be satisfied where possible, but which may be ignored if they cannot be met. Where a guide-type differential is not satisfied by pricing determined for a particular site the site may be added to a list of sites to be manually reviewed, for example by an expert analyst or a manager at an associated retail fuel site 1, 2. Alternatively, rules may be relaxed either manually or automatically such that optimal prices can be determined. That is, where it is determined that all of the currently specified rules cannot be satisfied, one or more of the rules may be made less restrictive. The one or more rules may be selected based upon an order which specifies the order in which rules should be relaxed if all of the rules cannot be satisfied.

The optimisation engine 11 is used to determine a set of prices which maximise some objective, whilst attempting to satisfy the rules specified by the constraints 10. In general terms, price optimisation is concerned with balancing profit with volume sales within specified price constraints. The optimisation engine takes as input a policy which indicates the relative importance of profit and volume sales for the optimisation and may be provided as a value between 0 and 100 where 0 indicates that profit is to be maximised and 100 indicates that volume is to be maximised, and values between 0 and 100 indicate relative proportions of profit and volume maximisation. The optimisation engine 11 may additionally be provided with data indicating information about the current market environment which can be taken into account in the generation of prices such as, for example data indicating expected variation in sales in a region or network. Examples of additional information may include data indicating that an event caused a reduction of sales on a particular day, or that a forthcoming event is likely to cause high sales such that strategy should be modified, for example to maximise profit.

The data engine 8 uses the demand model 9, constraints 10 and optimisation engine 11 to generate a recommended price 12 for each product at each associated retail fuel site 1, 2 in the network of associated retail fuel sites using modelling techniques well known in the art. For example, sequential quadratic programming, active set solvers, interior point solvers or other suitable non-linear optimisation techniques may be used to generate the recommended price 12. Additionally, a daily error-correction process such as a Kalman filter or dynamic linear model may be used to update model parameters in light of prediction errors. The data engine 8 may additionally provide output data 13 which can be used to predict competitor price changes, and to understand competitor pricing policies. Data 14 is generated indicating constraints which are specified by the constraints 10 but which are not satisfied by the recommended price 12. Reports 15 may also be generated by the data engine 8. The output data may be provided to the associated retail site 1, 2 in any convenient way, for example using the same method as that used to provide retail site and competitor data to the pricing system 7 from the retail site.

Referring now to FIG. 2A, a schematic functional block diagram of the pricing system is shown. The system has three functional blocks 101, 104, 105 which each take data as input, both from external sources and additionally from others of the three functional blocks, and each generate output data.

In more detail, a sales prediction block 101 takes as input own prices 102 and competitor prices 103 together with an updated model generated at a learning and updating block 104, and outputs expected sales for the current period. The expected sales output from the sales prediction block 101 are input to an optimisation generation block 105 which also takes as input site level volume constraints 106 (indicating minimum required volume sales for a site), price constraints 107 and costs 108. The optimisation generation block processes its inputs and generates a set of optimal prices and a corresponding forecast of sales, the forecast of sales being based upon the generated set of optimal prices. The forecast of sales and the optimal prices output from the optimisation generation block 105 is input to the learning and updating block 104, together with achieved sales during the period for which the optimal prices were generated and used. The updated model that is passed to the sales prediction block 101 is generated at the learning and updating block 104 based upon the forecast sales for the period and the achieved sales for the period. In this way, the sales prediction for the next period is improved.

The optimal prices for an associated retail fuel site i, generated at the optimisation generation block 105 of FIG. 2A, can be determined by solving an optimisation problem of the form shown in equation (1):

$$maximise {\sum }_{i = 1}^{m} {\sum }_{k = 1}^{p} {G}_{tik} \qquad ( 1 )$$

with respect to own prices: {Pₜᵢₖ}_{i=1 . . . m,k=1 . . . p};
subject to price constraints: {gₗ_{ᵢₖ}≧0}ₗ_{ᵢₖ}_{=1 . . . q}_{ᵢₖ}_{,i=1 . . . m,k=1 . . . p}; and
site level volume constraints:

$${\{ {\sum }_{k} {V}_{tik} \geq {L}_{ti} \}}_{i = 1 … m}$$

where:

i is an index indicating an ith one of m associated retail fuel sites;

j is an index indicating a jth one of n competitor sites;

k is an index indicating a kth one of p fuel products;

t is a time period;

Gₜᵢₖ indicates gross profit from sale of grade k at site i in time period t and can be modelled in the form shown below in equation (3);

Pₜᵢₖ indicates the current price of fuel product k at associated retail fuel site i and time t;

lᵢₖ is an index indicating an lᵢₖth one of qᵢₖ price constraints indicating constraints on price such as a constraint on price difference between own and competitor products for a particular fuel product k;

gₗ_{ᵢₖ} models the qᵢₖ price constraints as a linear function of own price, cost and competing prices for site i and fuel product k and has the form shown in equation (4) below;

Vₜᵢₖ indicates sales volume in time period t at site i for grade k and can be modelled in the form shown below in equation (2); and

Lₜᵢ indicates a minimum volume target for sales in time period t at site i.

Sales volume can be modelled in the form shown in equation (2):

Vₜᵢₖ=f(Vₛᵢₖ,Pₜᵢₖ,Pₜⱼₖ) (2)

where:

Vₛᵢₖ indicates previous sales at a time s<t;

Pₜⱼₖ indicates the current price of fuel product k at competitor retail fuel site j and time t; and

f is a model describing the relationships (referred to as elasticities) between own prices and competitor prices, based upon previous sales Vₛᵢₖ and generally is a log-log or log-linear model. The coefficients of the price terms of f are price elasticities.

Further details of the form and estimation of the model can be found in, for example the following, which are herein incorporated by reference: Singh, M. G., Bennavail, J.-C, (1993) “Experiments in the use of a knowledge support system for the pricing of gasoline products”, Information & Decision Technologies 18(6): 427-442; Krasteva, E., Singh, M. G., Sotirov, G., Bennavail, J.-C., and Mincoff, N., (1994) “Model Building for pricing decision making in an uncertain environment, Proc. IEEE International Conference on Systems, Man and Cybernetics”, San Antonio; and Bitran, G., Caldentey, R. and Mondeschein, S. (1998) “Coordinating clearance markdown sales of seasonal products in retail chains”, Operations Research 46(5): 609-624.

Accordingly gross profit Gₜᵢₖ can be modelled as shown in equation (3):

$${G}_{tik} = ( \frac{{P}_{til}}{1 - v} - {C}_{tik} ) {V}_{tik} = ( \frac{{P}_{tik}}{1 + v} - {C}_{tik} ) f ( {V}_{sik} , {P}_{tik} , {P}_{tjk} ) \qquad ( 3 )$$

where:

Pₜᵢₖ indicates current price of fuel product k at site i and time t as above;

Cₜᵢₖ indicates direct sales costs for fuel product k in time period t at site i; and

ν is the applicable sales tax rate.

The price constraints gₗ_{ᵢₖ} can be modelled in the form shown in equation (4):

gₗ_{ᵢₖ}(Pₜᵢₖ,Cₜᵢₖ,Pₜᵢₖ)≧0 (4)

where Pₜᵢₖ, Cₜᵢₖ and Pₜⱼₖ are as described above.

The optimisation problem of equation (1) can be solved using non-linear optimisation techniques well known in the art such as those described in Gill, P. E., Murray, W., and Wright, M. H., “Practical Optimisation” (1981), Academic Press, which is herein incorporated by reference. The optimisation provides a set of prices Pₜᵢₖ, indicating an optimal price at each site for each fuel product given various constraints that are applicable at the current time t.

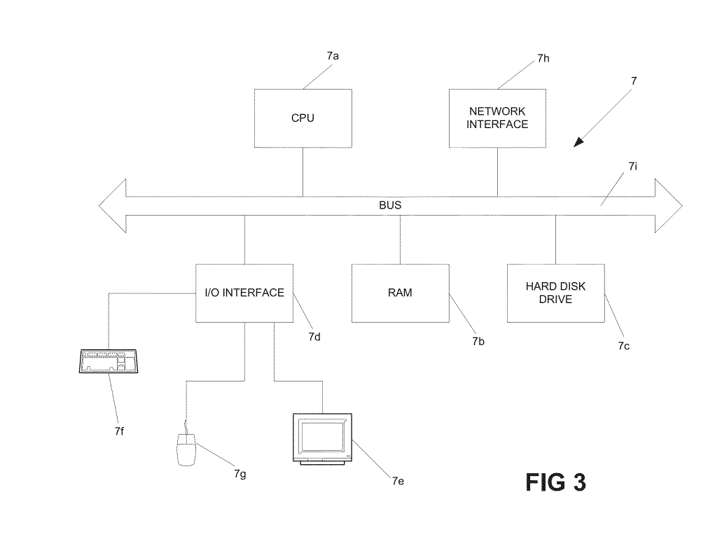

FIG. 3 shows a computer associated with the pricing system 7 of the system of FIG. 1 in further detail. It can be seen that the computer associated with the pricing system comprises a CPU 7a which is configured to read and execute instructions stored in a volatile memory 7b which takes the form of a random access memory. The volatile memory 7b stores instructions for execution by the CPU 7a and data used by those instructions. For example, in use, software used to determine optimal prices for retail fuel sites may be stored in volatile memory 7b.

The computer associated with the pricing system 7 further comprises non-volatile storage in the form of a hard disc drive 7c. Data such as retail fuel site data and competitor site data may be stored in the hard disc drive 7c. The computer associated with the pricing system 7 further comprises an I/O interface 7d to which are connected peripheral devices used in connection with the computer associated with the pricing system 7. The computer associated with the pricing system 7 has a display 7e configured so as to display output from the data engine. Input devices are also connected to the I/O interface 7d. Such input devices include a keyboard 7f, and a mouse 7g which allow user interaction with the data engine. A network interface 7h allows the computer associated with the pricing system 7 to be connected to an appropriate computer network so as to receive and transmit data from and to other computing devices such as computing devices provided at the retail fuel sites. The CPU 7a, volatile memory 7b, hard disc drive 7c, I/O interface 7d, and network interface 7h, are connected together by a bus 7i.

It is described above that a sales prediction block 101 takes as input own prices 102 and competitor prices 103 and outputs expected sales for the current period. Competitor prices 103 are typically collected by price collectors who visit competitor sites and observe competitor prices at the pump. The price collectors provide the competitor prices for analysis and processing, however it is desirable that the competitor prices are checked to ensure that the competitor prices are of sufficient quality.

FIG. 4 shows an arrangement for providing prices to a pricing system such as the pricing system of FIG. 2A. As shown in FIG. 4, a server 401 is arranged to communicate with a price collection device 402. The price collection device 402 is typically a mobile device associated with a price collector and may for example be an application running on a mobile telephone or a tablet computer.

The server 401 may provide an indication of one or more competitor sites for which data is to be collected by the data collector associated with the price collection device 402. Alternatively the data collector may collect prices from a predetermined one or more competitor sites. The price collection device is arranged to receive competitor price data associated with prices at the one or more competitor sites and to transmit the competitor price data to the server 401.

The input data for each competitor site is transmitted to the server together with data indicating a location associated with the input data. For example, the data indicating a location associated with the input data may be a location determined from hardware of the mobile device such as a GPS receiver or for example based upon cellular information as is known in the art. When the user inputs a competitor price for a particular site, a location of the device at the time of input of the data is generated and associated with the competitor price so as to provide a location associated with the competitor price data. The location may for example be a GPS coordinate.

The server 401 receives the competitor price data from the price collection device 402 together with the location associated with the competitor price data. The server 401 determines a location for the site associated with the competitor price data, for example based upon a lookup of data stored at the server for each site. The server processes the location associated with the competitor price data together with the location for the site associated with the competitor price data and generates output data indicative of correspondence between the stored location and the received location and communicates with a price approval module 403 for approval of the competitor price.

The stored location generally takes the same form as the location associated with the competitor data and processing the locations comprises determining a difference between the two locations. The output data indicative of correspondence between the stored location may take any convenient form, for example a value indicative of the difference between the two locations or the difference may for example be processed based upon one or more thresholds to generate data indicative of correspondence between the locations.

The received location and the stored location may for example each comprise a GPS coordinate and the GPS coordinates may be processed to generate a distance between the received location and the stored location. The distance may be processed to determine a classification for the distance, for example the distance may be classified as being within 10 kilometres, between 10 kilometres and 20 kilometres or greater than 20 kilometres. The classification may be used to provide a graphical indication to a user, as described below.

The price approval module 403 may for example be an interface associated with the server, however typically the price approval module is a device remote from the server associated with a further user such as a supervisor and the server transmits data to the price approval module for approval.

The price approval module may for example be a remote computer. Alternatively, in some embodiments the price approval module 403 is a mobile device associated with a further user. The mobile device is arranged to receive competitor prices associated with a competitor site from the server and to display the competitor prices to the associated user for approval. The competitor prices are typically displayed to the user together with data associated with a distance between a received location associated with the competitor price and a stored location associated with the competitor site.

Approved prices are processed at the server according to the modelling described above to generate price recommendations for one or more associated retail fuel sites 404. The price recommendations may be displayed to a user as part of a pricing module that may be configured and displayed as part of a pricing page for a user such as the pricing page described in US Patent Publication Number US2012/0198366, which is hereby incorporated by reference. Alternatively the price recommendations may be output for implementation at the associated retail fuel sites 404.

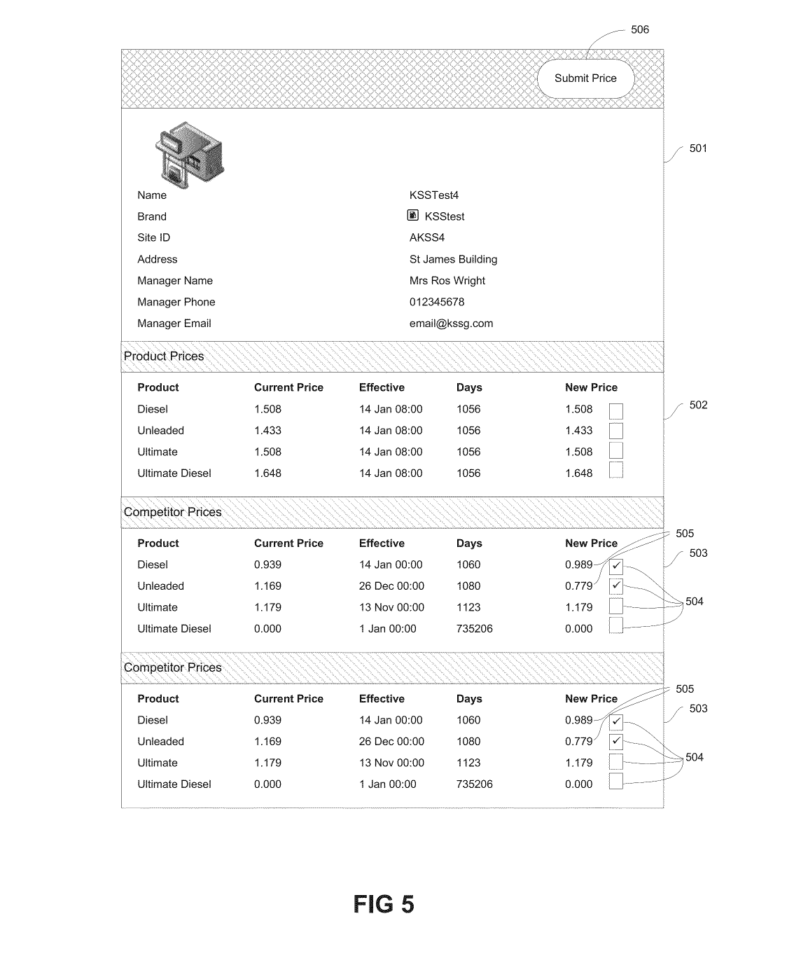

FIGS. 5 to 9 each show a schematic illustration of a user interface screen for competitor price input. The user interface screens may for example be displayed to a price collector on the price collection device 402 of FIG. 4 to allow the price collector to submit prices to the server 401.

Referring first to FIG. 5, a screen associated with a site KSSTest4 is schematically illustrated. The screen comprises site information component 501, site price component 502 and one or more competitor price components 503.

The site information component 501 provides information associated with site for which it is desirable to generate price information using the modelling described above.

Site price component 502 provides information associated with each fuel type of the site including an indication of each fuel type available at the site, a current price at the site, a date at which the current price became effective and a number of days for which the current price has been effective. The site price component 502 also provides an interface that allows a user to input a new price for each fuel type and if the user has the correct permissions the price may be transmitted to the site for implementation and/or automatically implemented at the site.

Each competitor price component 503 is associated with a competitor site and each competitor price component 503 includes an indication of the site with which it is associated. Each competitor price component 503 further includes information associated with each fuel type of the competitor site. The information associated with each fuel type includes a product name, current price indicating a last observed price, effective date and a number of days since the current price was changed. The competitor price component 503 additionally includes an interface that allows a user to input a new price for the fuel type, for example a price that is observed at the site by a price collector.

The interface for inputting a new price may take any convenient form. For example, as shown in FIG. 5, the interface may comprise a selection box 504 associated with each fuel type that allows a price collector to indicate that the observed price is different to the stored price for the fuel type. Upon receipt of an indication from a user that an observed price is different to a stored price a further interface may be provided to the user.

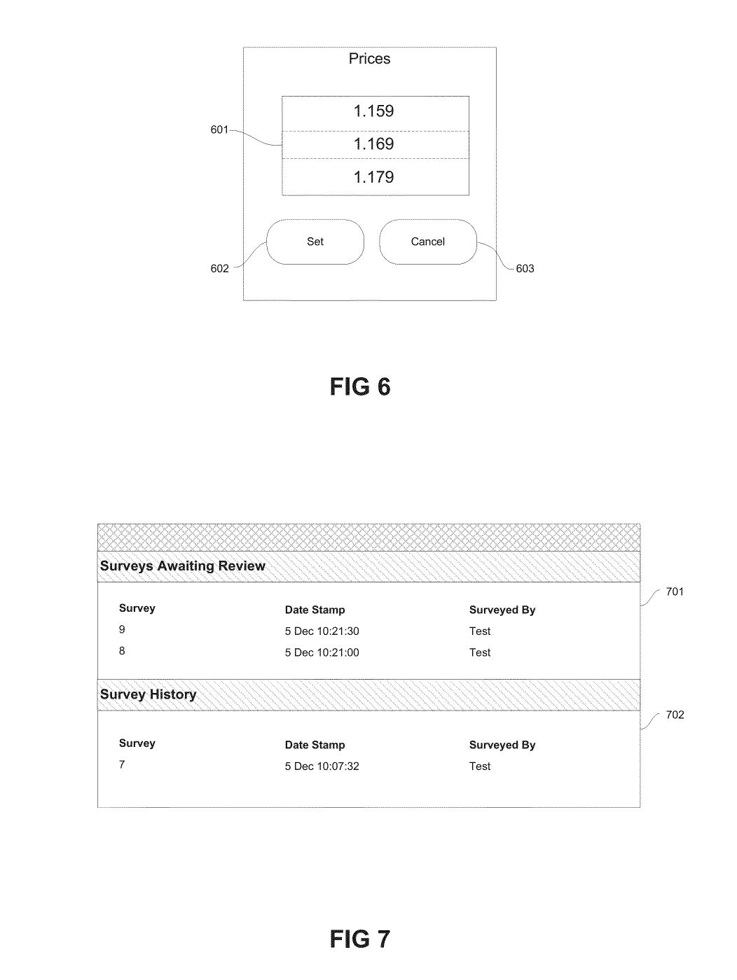

For example, as shown in FIG. 6, a price input scroll wheel 601 that initially indicates a current price and that allows a user to scroll to the observed price. The user may select a button 602 to set the price currently displayed on the scroll wheel or select a button 603 to cancel input of the price. The user interface for inputting prices described with reference to FIGS. 5 and 6 is particularly suited to input of prices on a mobile device with a touchscreen. It will however be appreciated that prices may be input in any convenient way, for example by typing a price into a price entry box in the competitor price component 503 of FIG. 5.

Prices that are input into the competitor price component 503 are displayed in an input price display 505 associated with each fuel type. Input prices may be provided with a visual indicator, for example indicating that a price exceeds a maximum expected price change. A price submission button 506 allows a price collector to submit prices to the server 401 of FIG. 4. As described above, the submitted prices may be processed by the server and provided to a price approval component 403.

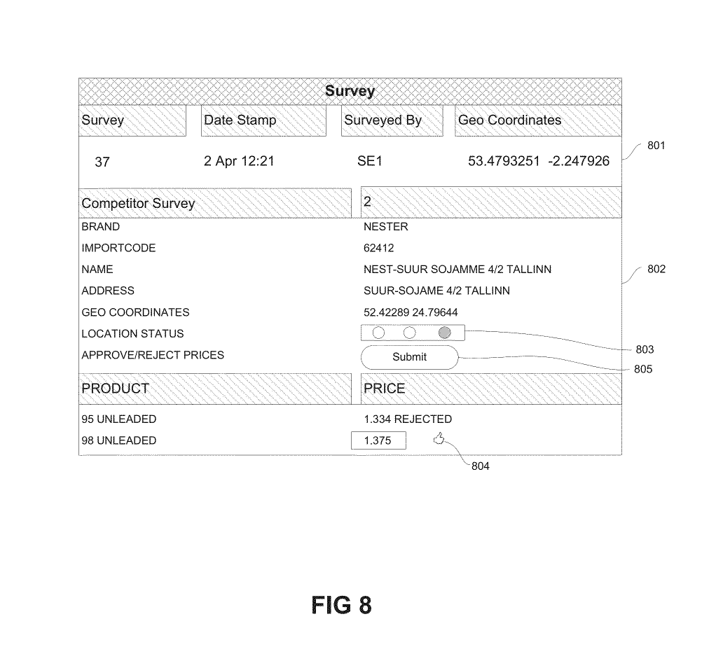

FIGS. 7 and 8 each show a schematic illustration of a user interface screen for competitor price approval. The user interface may for example be provided to a user using price approval component 403 of FIG. 4 to approve prices submitted server 401 by a price collector using price collection device 402. The user is typically a supervisor that reviews surveys provided by a plurality of price collectors.

Referring first to FIG. 7, a survey overview screen comprises a surveys awaiting review component 701 and a survey history component 702. The survey history component 701 indicates price surveys that have been recently reviewed and surveys awaiting review component 701 indicates price surveys that are awaiting review by a user. Upon receipt of a selection of a survey for review by a user a survey review screen such as the screen shown in FIG. 8 is displayed to the user.

Referring to FIG. 8, the survey review screen comprises a survey data component 801 and a site data component 802. The survey data component 801 indicates details of the survey that is being reviewed including a time and date of the survey, an indication of the price collector and an indication of a location associated with the survey. The location associated with the survey may take any convenient form as described above, for example a GPS coordinate.

The site data component 802 comprises data associated with the site associated with the survey and may include a brand associated with the site, a name of the site, an address and a location associated with the site. The site data component 802 may further comprise a graphical indicator 803 indicating a relationship between the location associated with the survey and the location associated with the site. It will be appreciated that the relationship between the locations can be displayed in any convenient way. For example, as shown in FIG. 8 the graphical indicator 803 may comprise a traffic light indicator that indicates green if the difference between the locations is less than a predetermined minimum distance, red if the difference between the locations is greater than a predetermined maximum distance and amber if the difference is between the maximum and minimum distances.

In some embodiments a user may be provided with an additional or alternative indication of the relationship between the location associated with the survey and the location associated with the site such as a map indicating the locations. For example the user may select an indication of distance and a map may be displayed.

The site data component 802 further comprises an indication of each fuel type of the site together with the price input by the price collector and an interface 804 that allows the user to indicate whether each price is accepted or rejected. User input indicating acceptance or rejection of prices may be confirmed using a submit interface 805. Confirmed prices are transmitted to the server 401 for processing in the generation of prices for sites 404.

Providing an indication of location associated with a survey and a site associated with the survey, for example a site to which the survey relates, allows a supervisor to confirm or reject prices provided as part of the survey based upon where the survey is submitted. Surveys that are submitted from a location that is close to a location of the site associated with the survey are typically more reliable and provide more accurate competitor price information as the prices provided as part of the survey are more likely to be recently observed prices for the site. It will be appreciated that in order to provide accurate prices using the modelling described above it is important that data used in the modelling is accurate and the methods and interfaces described above therefore improve prices generated using the modelling.

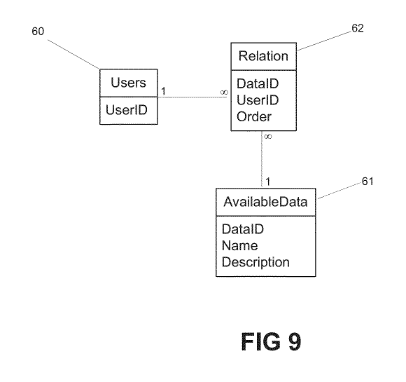

FIG. 9 is an entity diagram of a database suitable for storing and managing fuel price data. As shown in FIG. 9, the database has three tables: a Users table 60; an AvailableData table 61 and a Relation table 62. Each entry of the Users table 60 is associated with a user of the system, each entry of the AvailableData table 61 is associated with a data item that may be displayed as part of a pricing page and each entry of the Relation table 62 indicates a relationship between a user and a data item, together with an order associated with display of the data item. It will of course be appreciated that the database also has tables associated with fuel price data for own site retail fuel sites and competitor retail fuel sites.

The Users table 60 has a UserID field which is its primary key, and may additionally have fields for storing data associated with each user such as a name field and a permissions field associated with data that the user is allowed to view and modify. The AvailableData table 61 has a dataID field which is its primary key, a Name field for storing the name of a data item and a Description field for storing a description of the data item. The Relation table 62 has a DataID field which identifies a record of the AvailableData table 61, a UserID field which identifies a record of the Users table 60 and an Order field which defines an order for display of the data item identified by the DataID field relative to other data items to be displayed. For example, the Relation table 62 may store records of competitor sites associated with a user for which the user is to collect fuel price data, or may store records of competitor sites for which the user is responsible for approving fuel prices.

When a page is to be displayed for a particular user a lookup is carried out to identify records of the Relation table 62 having a UserID corresponding to the UserID of the particular user. The DataID of each identified record identifies a record of the AvailableData table 61 which corresponds to a data item to be displayed as part of the pricing page which can then be displayed to the user.

The Users table 60 may additionally have fields for storing data associated with user specific data processing such as processing to automatically generate notifications for the user.

It will be appreciated that the entity diagram of FIG. 9 provides a portion of a larger database structure suitable for carrying out the invention. The database structure may be arranged in any suitable way known in the art.

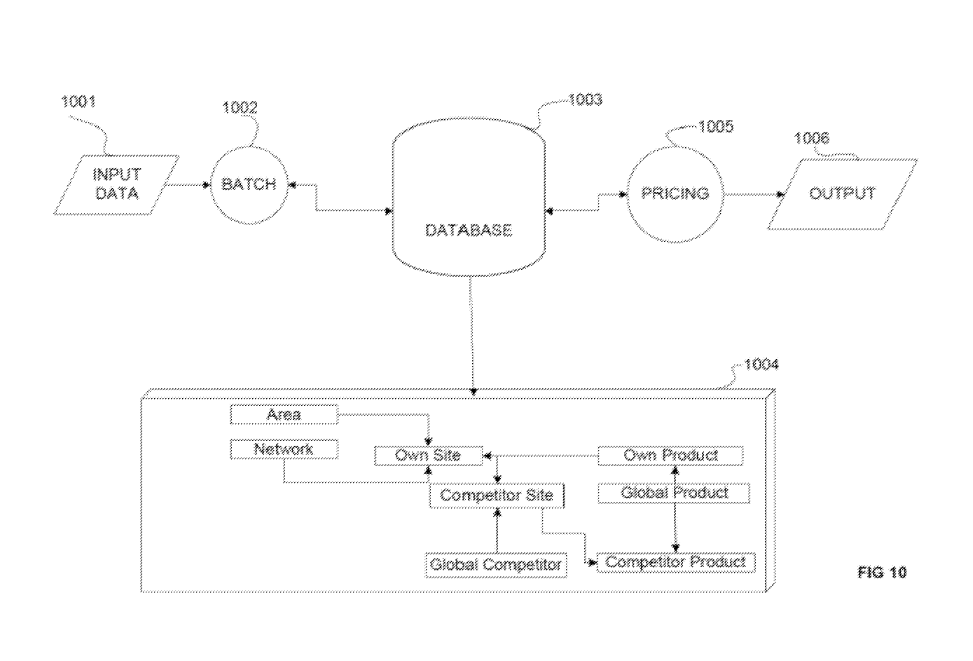

FIG. 10 is a schematic illustration of data flow in the pricing system described above. As shown in FIG. 10, input data 1001 is processed by batch processing 1002 at periodic intervals. The input data includes input competitor prices, for example obtained from competitor sites as described above, own site price changes, changes to costs and sales data. The batch processing 1002 processes the input data 1001 based upon data stored in a database 1003 that stores data associated with pricing for retail fuel sites to determine whether the input data satisfies one of a plurality of predetermined criteria associated with one or more retail fuel sites. The batch processing may for example determine whether input competitor prices have been approved, as described above.

The predetermined criteria are criteria that, if satisfied, require a new price to be generated for the one or more retail fuel sites associated with the criteria. For example, the predetermined criteria may include one or more checks on the input data 1001 to determine whether the input data 1001 includes a modification to a fuel price for a main competitor site stored in the database 1003 of an own site such that the modification requires prices to be generated for the own site. Alternatively or additionally the predetermined criteria may be associated with a change to costs for a fuel type associated with one or more own sites. Various other predetermined criteria will be apparent to one skilled in the art in light of the detail set out in the above description.

Schematic 1004 illustrates some of the data stored in the database 1003. In particular, as shown in schematic 1004, the database 1003 includes data associated with own sites, competitor sites, and products, and relationships therebetween.

Pricing processing 1005 is arranged to process the data stored in the database 1003 based upon the batch processing 1002 to generate output price recommendations 1006 for retail fuel sites, as described in detail above. For example, for each site identified by the batch processing 1002, fuel price data stored in the database 1004, including modifications received as part of the input data 1002, may be processed using the modelling described above with reference to equations (1) to (3). The pricing processing 1005 may additionally include user interactions with price recommendations that are automatically generated to determine final price recommendations for implementation at a retail fuel site.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A computer-implemented method of generating fuel price data, the method being implemented in a computer comprising memory in communication with a processor, the method comprising:
receiving, as input to the processor, fuel price data associated with a retail fuel site;
receiving, as input to the processor, a location associated with the received fuel price data;
receiving, as input to the processor, a location associated with the retail fuel site; and
if the location associated with the received fuel price data and the location associated with the retail fuel site satisfy a predetermined criterion, generating said fuel price data based upon the received fuel price data.

2. A method according to claim 1, wherein said fuel price data associated with a retail fuel site is received from a mobile computer.

3. A method according to claim 2, wherein the location associated with the received fuel price data is a location associated with said mobile computer.

4. A method according to claim 1, wherein the location associated with the retail fuel site comprises a geographical location of the retail fuel site.

5. A method according to claim 1, wherein the predetermined criterion is based upon a difference between the location associated with the received fuel price data and the location associated with the retail fuel site.

6. A method according to claim 1, wherein generating said fuel price data comprises processing said received fuel price data associated with a retail fuel site.

7. A method according to claim 1, wherein said generated fuel price data comprises fuel prices associated with a further retail fuel site.

8. A method according to claim 7, wherein said retail fuel site is a direct competitor for fuel sales of said further retail fuel site.

9. A method according to claim 1, further comprising determining if the location associated with the received fuel price data and the location associated with the retail fuel site satisfy a predetermined criterion.

10. A method according to claim 9, wherein said determining comprises:
generating data indicating a relationship between the location associated with the received fuel price data and the location associated with the retail fuel site.

11. A method according to claim 10, wherein said data indicating a relationship comprises a graphical indication of said relationship.

12. A method according to claim 10, further comprising providing said data indicating a relationship to a user.

13. A method according to claim 12, wherein providing said data indicating a user relationship to a user comprises transmitting said data indicating a relationship to a mobile device associated with the user.

14. A method according to claim 12, further comprising:
receiving user input based upon said data indicating a relationship, wherein said predetermined criterion is based upon said user input.

15. A method according to claim 10, wherein generating data indicating a relationship between the location associated with the received fuel price data and the location associated with the retail fuel site comprises:
processing said relationship based upon a plurality of predetermined criterion and selecting said data indicating a relationship from a plurality of respective relationships based upon said processing.

16. A computer-implemented method of generating fuel price data, the method being implemented in a computer comprising a memory in communication with a processor, the method comprising:
receiving, as input to the processor, fuel price data associated with a retail fuel site from a mobile device associated with a first user;
receiving, as input to the processor, location data associated with the received fuel price data, the location data being associated with a location of the mobile device associated with the first user;
receiving, as input to the processor, location data associated with the retail fuel site;
determining, by the processor, a relationship between the location associated with the received fuel price data and the location data associated with the retail fuel site; and
transmitting, by the processor, data associated with said relationship to a mobile device associated with a second user;
wherein the server is further arranged to receive, as input to the processor, data associated with said transmitted data from said mobile device associated with the second user; and
process the received fuel price data based upon the received data.

17. A system for generating fuel price data, the system comprising:
a server;
a mobile device associated with a first user; and
a mobile device associated with a second user;
wherein the mobile device associated with the first user is arranged to:
receive fuel price data associated with a retail fuel site; and
transmit the fuel price data and a location associated with the fuel price data to the server;
the server is arranged to:
receive the fuel price data and location associated with the fuel price data;
receive a location associated with the retail fuel site;
process the location associated with the fuel price data and the location associated with the retail fuel site to generate relationship data;
transmit the relationship data to the second mobile device;
wherein the mobile device associated with the second user is arranged to:
receive the relationship data from the server;
receive input data based upon the relationship data; and
transmit the input data to the server;
wherein fuel price data is generated based upon the received fuel price data associated with the retail fuel site and the input data transmitted to the server.

18. A system for generating fuel price data, the system comprising:
a processor; and
a memory in communication with the processor, the processor storing computer readable instructions arranged to cause the processor to:
receive, as input to the processor, fuel price data associated with a retail fuel site;
receive, as input to the processor, a location associated with the received fuel price data;
receive, as input to the processor, a location associated with the retail fuel site; and
if the location associated with the received fuel price data and the location associated with the retail fuel site satisfy a predetermined criterion, generate said fuel price data based upon the received fuel price data.

19. A computer readable medium carrying a computer program comprising computer readable instructions configured to cause a computer to carry out a method of:
receiving, as input to the processor, fuel price data associated with a retail fuel site;
receiving, as input to the processor, a location associated with the received fuel price data;
receiving, as input to the processor, a location associated with the retail fuel site; and
if the location associated with the received fuel price data and the location associated with the retail fuel site satisfy a predetermined criterion, generating said fuel price data based upon the received fuel price data.
